(19) United States
(12) Patent Application Publication
(10) Pub. No.: US 2024/0270227 A1
(43) Pub. Date: Aug. 15, 2024

(54) SYSTEMS, METHODS, AND APPARATUS FOR AN INTELLIGENT BRAKING SYSTEM

(71) Applicant: Toyota Motor Engineering & Manufacturing North America, Inc., Plano, TX (US)

(72) Inventor: Katsumi NAGATA, Foster City, CA (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/108,560

(22) Filed: Feb. 10, 2023

(51) Int. Cl. B60T 17/22; B60T 8/171; F16D 65/18

(52) U.S. Cl. CPC B60T 17/221; B60T 8/171; F16D 65/18

(57) ABSTRACT

A system for intelligently applying a brake on a vehicle. The system includes a rotor connected to a wheel on the vehicle, a brake pad positioned adjacent to the rotor, a plurality of pistons, a plurality of regulators each coupled to a respective piston of the plurality of pistons, a sensor, and an electronic control unit (ECU) coupled to the plurality of regulators and the sensor. The brake pad may be configured to contact the rotor. The plurality of pistons may each be configured to contact a respective portion of the brake pad. The plurality of regulators may each be configured to control movement of the respective piston of the plurality of pistons. The sensor may be configured to detect sensor data related to a status of the brake pad. The ECU may be configured to control the plurality of regulators based on a request and the sensor data.

### BACKGROUND

### Field

The present disclosure relates to systems, methods, and apparatus for providing an intelligent braking system.

### Description of the Related Art

For a conventional braking system on a vehicle, when a driver applies pressure on a brake pedal, a master cylinder pushes brake fluid to each caliper or brake drum of the braking system. The caliper or the brake drum then actuates a piston or a wheel cylinder to press a brake pad or a brake shoe towards a rotor or a drum to apply braking force. In such a mechanical system, the driver typically learns of any issue(s) with the braking system by hearing a loud noise from the braking system (e.g., while the vehicle is backing up or being driven with no braking force being applied). The noise can be indicative of various worn parts of the braking system, and if the noise or the worn parts are not checked promptly, the braking system may fail at any moment and result in a very dangerous situation (e.g., the braking system may fail while the vehicle is being driven). Hence, there is a need for more advanced systems, methods, and apparatus to provide an intelligent braking mechanism within a vehicle so as to lengthen the lifespan of the braking system and to apply the brake more effectively and efficiently.

### SUMMARY

Described herein is a system for intelligently applying a brake on a vehicle. The system includes a rotor connected to a wheel on the vehicle, a brake pad positioned adjacent to the rotor and configured to contact the rotor to slow down or stop movement of the rotor such that movement of the wheel is slowed down or stopped, a plurality of pistons each configured to contact a respective portion of the brake pad to cause the respective portion of the brake pad to contact the rotor, a plurality of regulators each coupled to a respective piston of the plurality of pistons and configured to control movement of the respective piston of the plurality of pistons, a sensor configured to detect sensor data related to a status of the brake pad, and an electronic control unit (ECU) coupled to the plurality of regulators and the sensor. The ECU may be configured to receive a signal indicative of a request to apply the brake on the vehicle and control the plurality of regulators to cause the brake pad to contact the rotor based on the signal and the sensor data.

Also described is a vehicle having a system for intelligently applying a brake on the vehicle. The vehicle includes a rotor connected to a wheel on the vehicle, a brake pad positioned adjacent to the rotor and configured to contact the rotor to slow down or stop movement of the rotor such that movement of the wheel is slowed down or stopped, a plurality of pistons each configured to contact a respective portion of the brake pad to cause the respective portion of the brake pad to contact the rotor, a plurality of regulators each coupled to a respective piston of the plurality of pistons and configured to control movement of the respective piston of the plurality of pistons, a sensor configured to detect sensor data related to a status of the brake pad, and an ECU coupled to the plurality of regulators and the sensor. The ECU may be configured to receive a signal indicative of a request to apply the brake on the vehicle and control the plurality of regulators to cause the brake pad to contact the rotor based on the signal and the sensor data.

Moreover, also described is a method for intelligently applying a brake on a vehicle. The method includes receiving, by an ECU, a signal indicative of a request to apply the brake on the vehicle, detecting, by a sensor coupled to the ECU, sensor data indicative of a status of a brake pad on the vehicle, the brake pad configured to contact a rotor connected to a wheel on the vehicle to slow down or stop movement of the wheel, and controlling, by the ECU, a plurality of regulators based on the signal and the sensor data, the plurality of regulators each coupled to a respective piston of a plurality of pistons to actuate and cause the respective piston of the plurality of pistons to contact a respective portion of the brake pad such that the brake pad contacts the rotor to slow down or stop the movement of the wheel.

### BRIEF DESCRIPTION OF THE DRAWINGS

Other systems, methods, features, and advantages of the present invention will be or will become apparent to one of ordinary skill in the art upon examination of the following figures and detailed description. It is intended that all such additional systems, methods, features, and advantages be included within this description, be within the scope of the present invention, and be protected by the accompanying claims. Component parts shown in the drawings are not necessarily to scale, and may be exaggerated to better illustrate the important features of the present invention. In the drawings, like reference numerals designate like parts throughout the different views, wherein:

FIG. 1 is a block diagram illustrating a system for intelligently applying a brake on a vehicle according to an embodiment of the present invention;

FIG. 2 is a block diagram illustrating a system for intelligently applying a brake on a vehicle according to an embodiment of the present invention;

FIGS. 3A and 3B are illustrations of brake pads including electrical impedance material according to an embodiment of the present invention;

FIGS. 4A and 4B are illustrations of brake pads including, respectively, grid sensor material and a grid sensor or a wire mesh according to respective embodiments of the present invention;

FIG. 5 is a block diagram illustrating a system for intelligently applying a brake on a vehicle according to an embodiment of the present invention;

FIG. 6 is a block diagram illustrating a system for intelligently applying a brake on a vehicle according to an embodiment of the present invention;

FIG. 7 is a block diagram illustrating a system for intelligently applying a brake on a vehicle according to an embodiment of the present invention;

FIG. 8 is a block diagram illustrating a system for intelligently applying a brake on a vehicle according to an embodiment of the present invention; and

FIG. 9 is a flowchart illustrating a method for intelligently applying a brake on a vehicle according to an embodiment of the present invention.

### DETAILED DESCRIPTION

Advantages and benefits of the intelligent braking system described herein include dynamically enhancing braking performance and maximizing braking force on a vehicle. The intelligent braking system described herein may utilize artificial intelligence (AI) analytics (e.g., based on sensor data and/or crowdsourced and/or big data) to dynamically change the pressure applied to a plurality of pistons for contacting a brake pad in order to consistently achieve an even and uniform contact between the brake pad and a rotor on the vehicle. This allows the brake pad to last longer. The sensor data and/or the crowdsourced and/or big data may also enable an advanced warning for a brake pad replacement.

Moreover, the intelligent braking system described herein may utilize an independent regulator (e.g., a solenoid) for each piston of a multi-piston braking system. Each regulator may be independently controlled by an intelligent braking controller (e.g., an intelligent braking electronic control unit (ECU)) to actuate each piston corresponding to a respective portion of the brake pad as needed to achieve the even and uniform contact between the brake pad and the rotor and prolong the lifespan of the brake pad. A maximized contact area between the brake pad and the rotor would also enable a maximum braking force to safely and effectively slow down or stop the vehicle.

Furthermore, the intelligent braking system described herein may include a brake pad with one or more sensors to detect and send brake pad condition data to the intelligent braking ECU. The sensor data (e.g., the brake pad condition data) can provide information related to the wearing of the brake pad and allow the intelligent braking ECU to dynamically control a plurality of pistons to enable an even wearing of the brake pad and achieve a maximum contact area between the brake pad and the rotor on the vehicle.

Also, the intelligent braking system described herein may utilize the ΔI analytics to dynamically control each piston of the plurality of pistons within a caliper on the vehicle to maximize the contact area between the brake pad and the rotor and provide the maximum braking force.

Additionally, the intelligent braking system described herein may utilize other sensors such as, e.g., a radar sensor, a LIDAR sensor, an IMU sensor (used to detect, e.g., three-dimensional movement of the vehicle by measuring acceleration with respect to each axis of the three-dimensional movement—can generate data to be used to calculate stability, roll, pitch, yaw, etc.), a camera, etc. to determine how the vehicle is moving or braking under various driving conditions to provide stability control by the intelligent braking system when the vehicle is slowing down or stopping.

The intelligent braking system described herein may also communicate with a remote server (e.g., a cloud server). The remote server may provide a brake system maintenance notification to a user when the brake pad or the braking system needs maintenance (e.g., based on the sensor data) even before any malfunction occurs. The driving or braking behavior of the vehicle communicated to the remote server may allow, e.g., an automotive OEM (original equipment manufacturer) of one or more components of the braking system to utilize such information captured by the intelligent braking system to continuously improve the capability of the braking system and enhance the AI algorithm or machine learning model used by the AI analytics.

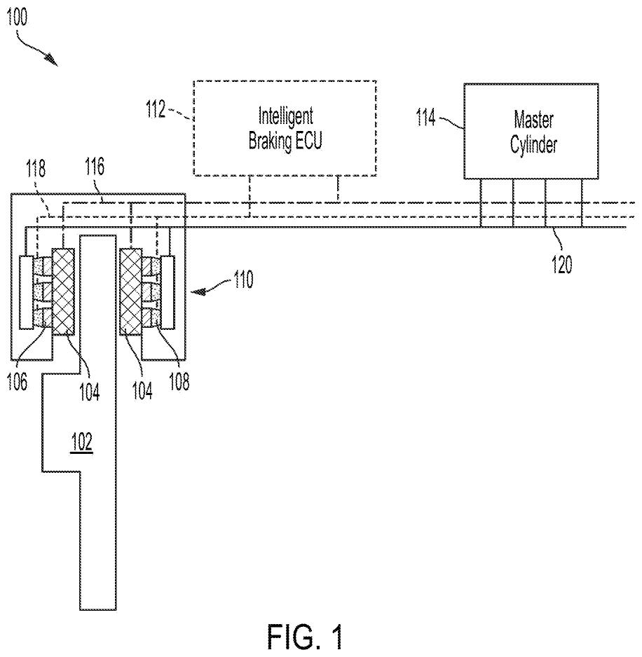

Turning to FIG. 1, a system 100 for intelligently applying a brake on a vehicle (not shown) is disclosed. The system 100 includes a rotor 102, one or more brake pads 104, a plurality of pistons 106, a plurality of regulators 108, a caliper 110, an intelligent braking electronic control unit (ECU) 112, a master cylinder 114, a brake pad sensor line 116, a regulator control line 118, and a brake hose 120. While only a single rotor 102 is illustrated with the other associated components in FIG. 1, it would be apparent to one of ordinary skill in the art that the system 100 may include more than a single set of the components illustrated in FIG. 1, e.g., depending on a number of wheels on the vehicle.

The brake apparatus described herein (e.g., as illustrated in FIG. 1 by at least the rotor 102, the one or more brake pads 104, the plurality of pistons 106, the plurality of regulators 108, and the caliper 110) may include or be, e.g., disc-type brakes, drum-type brakes, or the like, as would be apparent to one or ordinary skill in the art and usable with various embodiments described herein.

The rotor 102 may be connected to a wheel (not shown) on the vehicle and turn with the wheel based on a driving force generated by, e.g., an engine or a motor-generator (not shown) on the vehicle. The engine or the motor-generator on the vehicle may be connected to the wheel via various intermediate components well known to one of ordinary skill in the art.

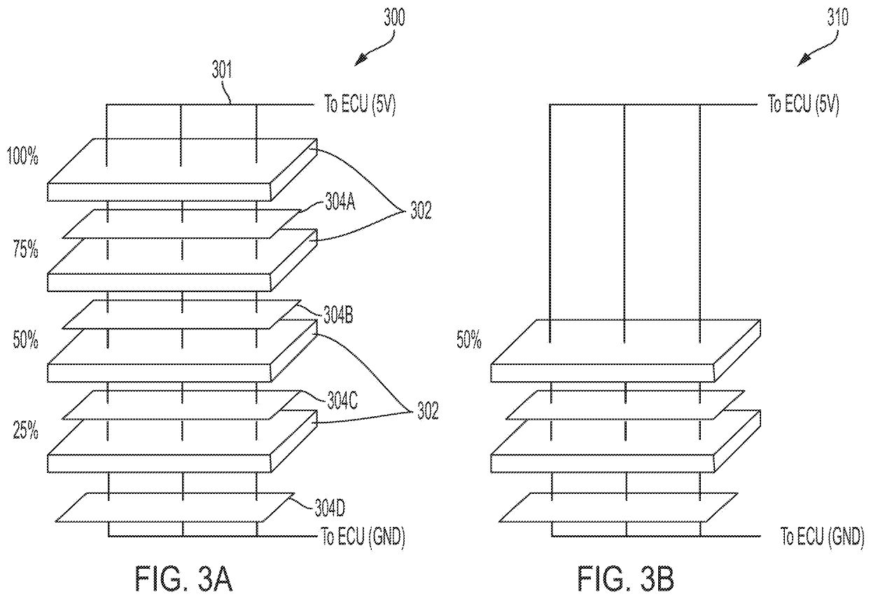

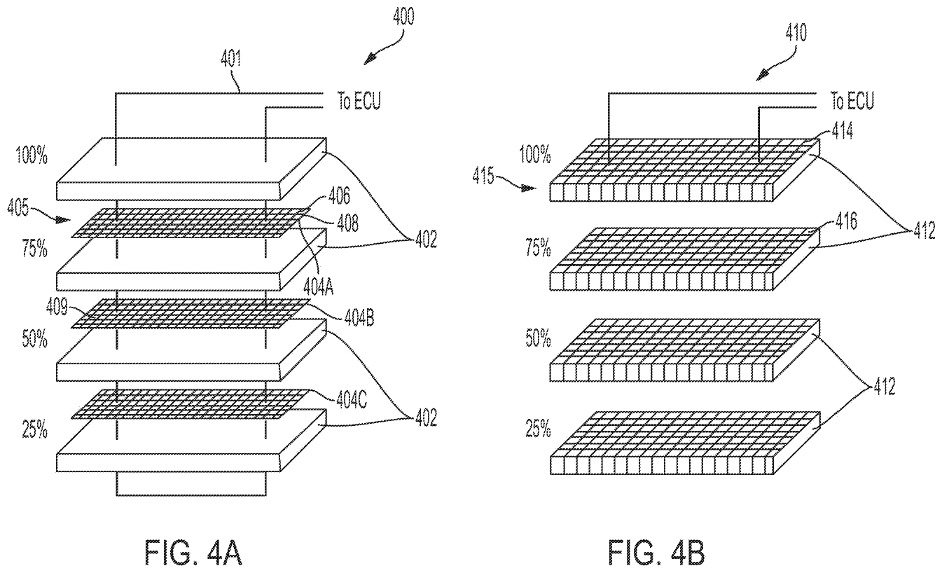

The one or more brake pads 104 may be positioned adjacent to the rotor 102 and configured to contact the rotor 102 to slow down or stop movement of the rotor 102 such that movement of the wheel is slowed down or stopped when the brake is applied (e.g., by a driver putting pressure on a brake pedal on the vehicle). In various embodiments, the one or more brake pads 104 may be coupled to one or more sensors (not shown) that are configured determine a status of the one or more brake pads 104. See FIGS. 3A, 3B, 4A, and 4B and the description related thereto presented herein for examples of such sensors that are configured to determine the status of the one or more brake pads 104. The one or more sensors may detect sensor data related to a status of the brake pads 104 (e.g., a remaining percentage or amount of the brake pads 104 at various portions of the brake pads 104).

The plurality of pistons 106 may each be configured to contact a respective portion of the brake pads 104 to cause the respective portion of the brake pads 104 to contact the rotor 102. In various embodiments, the plurality of pistons 106 may be actuated by, respectively, the plurality of regulators 108. The plurality of regulators 108 may each be coupled to a respective one of the plurality of pistons 106 and configured to control movement of the respective one of the plurality of pistons 106. In various embodiments, the plurality of pistons 106 and the plurality of regulators 108 may be housed in the caliper 110.

In some embodiments, the plurality of regulators 108 may each control an amount of brake fluid to and/or from each of the plurality of pistons 106. For example, the plurality of regulators 108 may be connected, via the brake hose 120, to the master cylinder 114 which may control the movement of the brake fluid to and/or from the plurality of regulators 108. When the brake is to be applied (e.g., based on the driver putting pressure on the brake pedal on the vehicle), the master cylinder 114 may push a predetermined amount of the brake fluid to the plurality of regulators 108 based on the sensor data regarding the corresponding portions of the brake pads 104 (e.g., relating to how much of the brake pads 104 is remaining at the corresponding portions of the brake pads 104). Then, each of the plurality of regulators 108 may be controlled individually and independently to release a particular amount of the brake fluid for the corresponding one of the plurality of pistons 106. The particular amount of the brake fluid released for each of the plurality of pistons 106 may be determined by the intelligent braking ECU 112 and controlled via a controlling structure such as, e.g., a flap, a valve, etc. (or any structure or method known in the art) in each of the plurality of regulators 108 controlled individually and independently by the intelligent braking ECU 112.

In some embodiments, the plurality of pistons 106 and the plurality of regulators 108 may be actuated and controlled electronically without any brake fluid (i.e., allowing the master cylinder 114 and the brake hose 120 to be optional in such embodiments). That is, the plurality of regulators 108 may receive an electrical signal from the intelligent braking ECU 112 via the regulator control line 118 to control the movement of the plurality of pistons 106 individually and independently with respect to the corresponding portions of the brake pads 104 (e.g., based on the sensor data regarding the corresponding portions of the brake pads 104 obtained and processed by the intelligent braking ECU 112). In some embodiments, the plurality of regulators 108 may cause the corresponding portions of the brake pads 104 to engage the rotor 102 via the corresponding ones of the plurality of pistons 106 or corresponding ones of other actuators or actuating mechanisms (not shown) to cause the corresponding portions of the brake pads 104 to engage the rotor 102.

As illustrated in FIG. 1 and described herein, the intelligent braking ECU 112 may be connected to the one or more brake pads 104 as well as the plurality of regulators 108. Specifically, in various embodiments, the intelligent braking ECU 112 may be connected via the brake pad sensor line 116 to the one or more sensors described herein with respect to the one or more brake pads 104 (e.g., with the one or more sensors being part of or being connected to the one or more brake pads 104). Moreover, the intelligent braking ECU 112 may be connected via the regulator control line 118 to the plurality of regulators 108. The intelligent braking ECU 112 may receive data related to the status of the one or more brake pads 104 from the one or more sensors connected to or incorporated into the one or more brake pads 104 (via the brake pad sensor line 116) and determine the amount of pressure to be applied by each of the plurality of pistons 106 (to be actuated via each of the plurality of regulators 108) against the corresponding portion of the brake pads 104.

The actuation via each of the plurality of regulators 108 may be (i) based on the data related to the status of the one or more brake pads 104 (e.g., the percentage or amount of the brake pads 104 remaining at each of the corresponding portions of the brake pads 104) and/or (ii) to achieve an even and uniform (i.e., maximized) contact between the brake pads 104 and the rotor 102. For example, when a first portion of the brake pads 104 has a greater percentage or amount of the brake pad material remaining than a second portion (i.e., the sensor data from the one or more sensors indicates an uneven wear on the brake pads 104), the first one of the plurality of pistons 106 corresponding to the first portion of the brake pads 104 may be pushed less than a second one of the plurality of pistons 106 corresponding to the second portion of the brake pads 104 such that the contact between the first portion of the brake pads 104 and the rotor 102 and the contact between the second portion of the brake pads 104 and the rotor 102 are even.

In various embodiments, the intelligent braking ECU 112 included in the system 100 may include or couple to one or more processors. These one or more processors may be implemented as a single processor or as multiple processors. For example, the intelligent braking ECU 112 may be a microprocessor, a data processor, a microcontroller, or other controller, and may be electrically coupled to some or all of the other components within the system 100. In some embodiments, the intelligent braking ECU 112 may be a dedicated ECU configured to control the components connected to the intelligent braking ECU 112 within the system 100. In some embodiments, the intelligent braking ECU 112 may be coupled to or be a part of a vehicle ECU (not shown) which controls other components of the vehicle as well as the components of the system 100.

Some or all of the other components of the system 100 may also include one or more controllers which may include one or more processors specifically designed and programmed for the respective functions of the components. The functions of the controllers may be implemented in a single controller or in multiple controllers. Each controller may receive data from one or more of the components of the system 100, may make determinations based on the received data, and may control the operations of the respective component based on the determinations. The request may be based on a user input (e.g., a driver) or one or more types of data captured by, e.g., one or more sensors.

The system 100 may also include a memory (not shown) including any non-transitory memory and may store data usable by the system 100. The memory may be located within or on the vehicle and may be referred to as a local memory. The memory may also be located remote from the vehicle and may be referred to as a remote memory.

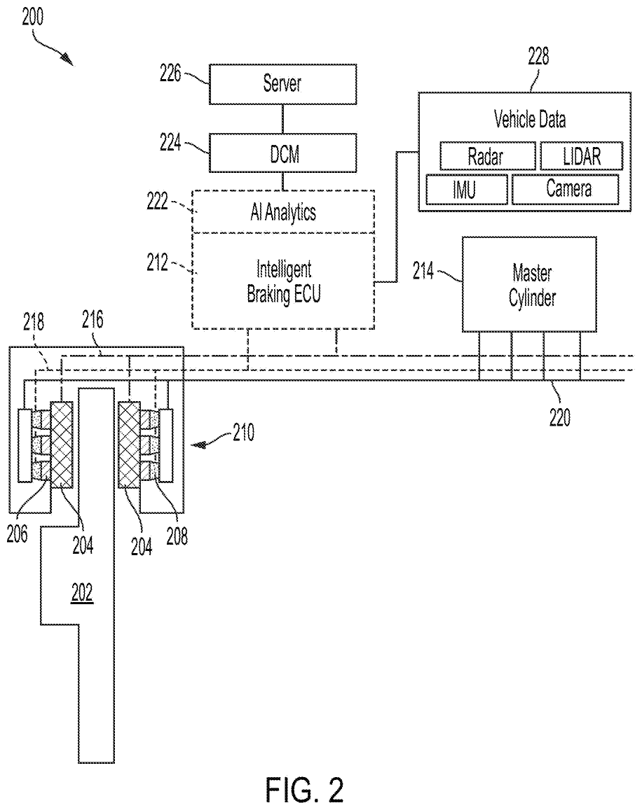

Turning to FIG. 2, a system 200 for intelligently applying a brake on a vehicle is disclosed. The system 200 may include similar components as described herein with respect to FIG. 1, such as, e.g., a rotor 202 (similar to the rotor 102), one or more brake pads 204 (similar to the one or more brake pads 104), a plurality of pistons 206 (similar to the plurality of pistons 106), a plurality of regulators 208 (similar to the plurality of regulators 108), a caliper 210 (similar to the caliper 110), an intelligent braking ECU 212 (similar to the intelligent braking ECU 112), a master cylinder 214 (similar to the master cylinder 114), a brake pad sensor line 216 (similar to the brake pad sensor line 116), a regulator control line 218 (similar to the regulator control line 118), and a brake hose 220 (similar to the brake hose 120). Similar to the components illustrated in FIG. 1, while only a single rotor 202 is illustrated with the other associated components in FIG. 2, it would be apparent to one of ordinary skill in the art that the system 200 may include more than a single set of the components illustrated in FIG. 2, e.g., depending on a number of wheels on the vehicle. Furthermore, the components of the system 200 similar to the corresponding components of the system 100 may have similar structures and perform similar functions as described herein with respect to FIG. 1 and the corresponding components of the system 100.

In various embodiments, the system 200 may also include an artificial intelligence (AI) analytics module or circuitry 222, a transceiver 224, and one or more sensors 228.

The AI analytics module or circuitry 222 may include a hardware such as a device, an apparatus, or a circuitry and/or a software configured or programmed to, e.g., analyze a set of data via an AI algorithm and/or a machine learning model. In various embodiments, the AI analytics module or circuitry 222 may be connected to or be a part of the intelligent braking ECU 212. The AI analytics module or circuitry 222 may utilize various sensor data (as described herein) and/or crowdsourced or big data as input for the AI algorithm and/or the machine learning model to predict a braking behavior of the vehicle and/or a wearing pattern of the brake pads 204 on the vehicle. For example, the AI analytics module or circuitry 222 may collect data related to driving behavior including, e.g., how hard a driver brakes responsive to various road conditions, etc. Moreover, the driving behavior data may include driving behavior data from a plurality of other vehicles. The driving behavior data may be stored on a memory and maintained and/or sorted based on various parameters such as a class of driving pattern (e.g., based on a level of aggressiveness, etc.), one or more driving or road conditions (e.g., emergency conditions), driver identity, vehicle type or brand, etc. Such driving behavior data may be utilized by the system 200 (e.g., the intelligent braking ECU 212) to, e.g., determine how to control the plurality of regulators 208, the wearing pattern of the brake pads 204, a timing of expected brake pad replacement, how to autonomously maneuver the vehicle or apply the brake, etc.

Moreover, the AI analytics module or circuitry 222 may be utilized by the system 200 to determine a pattern of braking behavior from other vehicles or a driver-preferred braking behavior, which can enable, e.g., a driver to set a desired pattern or level of aggressiveness of braking or an emergency or automatic braking behavior responsive to one or more road conditions (e.g., based on, respectively, how the driver has historically applied the brake in the vehicle or how other vehicles have applied their brakes over a period of time and responsive to the one or more road conditions). In some embodiments, the data used as input for the AI analytics module or circuitry 222 may be collected from a remote server (e.g., a cloud server such as a remote server 226 described herein) which may collect, from various sources including a plurality of other vehicles, crowdsourced or big data to be utilized by the AI analytics module or circuitry 222.

In various embodiments, the transceiver 224 may be referred to as a data communication module (DCM) and be configured to communicate with the remote server 226. The transceiver 224 may be utilized to send information related to the braking behavior or the sensor data regarding the brake pads 204 to the remote server 226, a user (e.g., a driver using a mobile device to receive the information), and/or an entity or individual associated with, e.g., an automotive OEM (original equipment manufacturer) such as an engineer, and/or enable an OTA (over-the-air) software update for the intelligent braking ECU 212 to improve the system 200 (e.g., related to the control of the plurality of regulators 208).

The transceiver 224 may be a network access device capable of communicating via a communications protocol (e.g., a wireless protocol). For example, the transceiver 224 may communicate via Bluetooth, Wi-Fi, a cellular protocol, V2V (vehicle-to-vehicle) communications, Zigbee, or any other communications (e.g., wireless) protocol. The transceiver 224 may also communicate with any device on the vehicle and/or any remote device.

Moreover, the user device (not shown) which may communicate with the transceiver 224 in the system 200 may be a device on or integrated within the vehicle, a smartphone, a tablet, or the like running an application (e.g., a software program) for displaying information related to, e.g., the wearing of the brake pads 204. The user device may be used by the driver, the passenger, or the like to view the information related to the wearing of the brake pads 204 (e.g., which portion(s) and/or how much of the brake pads 204 have been worn out, why the brake pads 204 may have worn out unevenly based on for example a history of how various components of the system 200 such as the plurality of pistons 206 and the plurality of regulators 208 have behaved for a prescribed period of time, suggested change(s) to driving and/or braking habit, etc.) and/or input an instruction or a confirmation to change an autonomous driving and/or operation (e.g., braking) of the vehicle (e.g., based on the uneven wearing of the brake pads 204).

Furthermore, the information described herein regarding, e.g., the uneven wearing of the brake pads 204 may be utilized by an engineer (e.g., of the automotive OEM) to design the OTA software update for updating, e.g., the intelligent braking ECU 212 and/or a brake apparatus including the brake pads 204 and/or any other component(s) in the system 200. The foregoing information may allow an owner of the vehicle to know how much of the brake pads 204 are left in the vehicle and when the vehicle should be serviced (e.g., prior to encountering any issues). That is, a user may view or access such information on a vehicular display or a smartphone application and take preventative/proactive measures to address potential brake or brake pad issues. Moreover, such information may be utilized for a health check of a vehicle to show when a brake service should be done as a preventative/predictive maintenance (e.g., by predicting how much of the brake pads 204 may wear out over how long of a period of time based on the detected data and information related to the wearing of the brake pads 204) to avoid an emergency or a failed braking system. The intelligent braking ECU 212 may continuously detect and monitor the condition of the brake pads 204 such that a braking performance may be improved.

In some embodiments, the one or more sensors 228 may collect vehicle data (i.e., sensor data) and include an image sensor such as, e.g., a radar sensor, a LIDAR sensor, an IMU sensor, and/or a camera, or any other image sensor capable of detecting light having any wavelength. One or more of such sensors may be utilized to collect the sensor data (e.g., image data). These sensors may be coupled to the intelligent braking ECU 212 and/or a vehicle ECU (not shown) and collect the sensor data to be utilized by the intelligent braking ECU 212 and/or the vehicle ECU. For example, the camera and/or other sensors on the vehicle may be utilized to detect one or more road conditions within a predetermined area near the vehicle such as, e.g., black ice, puddle, etc. and cause the vehicle ECU and/or the intelligent braking ECU 212 to, e.g., activate ABS (anti-lock braking system) with steering control to ensure that the vehicle does not go out of control while being slowed down or stopped in anticipation of the detected road conditions or maneuvered through the detected road conditions.

In some embodiments, such sensor data may be collected from other vehicles (e.g., in front of the vehicle) via, e.g., V2V (vehicle-to-vehicle) communication (e.g., utilizing the transceiver 224) which allows the vehicle to be alerted of upcoming road conditions such as those described above, and the vehicle ECU may instruct the intelligent braking ECU 212 to react (or the intelligent braking ECU 212 may proactively react) as needed. In some embodiments, location data may be used—such as those detected by a location sensor (not shown) such as those utilizing data from a GPS (global positioning system). That is, for example, a first vehicle may detect the location of itself (e.g., the relative distance and/or orientation with respect to a second vehicle in front of the first vehicle) and that of the second vehicle, receive data regarding one or more upcoming road conditions detected by the second vehicle, and depending on the time at which the first vehicle is expected to encounter the detected road conditions (based on, e.g., the speed or velocity at which the first vehicle is traveling), the vehicle ECU on the first vehicle may instruct the intelligent braking ECU 212 on the first vehicle to automatically react (or the intelligent braking ECU 212 may proactively react) accordingly (e.g., activate the ABS) at the required timing.

As a brief aside, the location sensor may include any sensor capable of detecting data corresponding to a location of the vehicle. For example, the location sensor may include one or more of a GPS sensor, an IMU (inertial measurement unit) sensor, or the like. The GPS sensor may detect data corresponding to a location of the vehicle. For example, the GPS sensor may detect global positioning coordinates of the vehicle. The IMU sensor may include one or more of an accelerometer, a gyroscope, or the like and detect inertial measurement data corresponding to a position, a velocity, an orientation, an acceleration, or the like of the vehicle. The inertial measurement data may be used to identify a change in location of the vehicle, which the vehicle ECU may track in order to determine the location of the vehicle.

Referring back to FIG. 2, the one or more sensors 228 may detect and/or enable the intelligent braking ECU 212 and/or the vehicle ECU to determine that vehicle stability is being lost (i.e., the vehicle may be swerving in and out of lanes uncontrollably due to one or more road conditions based on, e.g., image data detected by the one or more sensors 228). In response to the detected loss of control, the intelligent braking ECU 212 may, e.g., activate the ABS so as to lessen the swerving and/or send a signal to the vehicle ECU to activate, e.g., an autonomous steering control to allow the vehicle to regain control. In some embodiments, the braking and/or steering control may include one or more predetermined actions responsive to the encountered road conditions (and adjusted as needed based on, e.g., the sensor data regarding the one or more brake pads 204).

In some embodiments, the one or more sensors 228 may be connected to a main body of the vehicle and may detect image data corresponding to an environment of the vehicle, data corresponding to a vehicle cabin (not shown), or the like. The one or more sensors 228 may include one or multiple image sensors which may be oriented to detect image data in any direction relative to the main body of the vehicle (and/or within the vehicle cabin). For example, the one or more sensors 228 may include four or more radar detectors to detect radar data on four or more sides of the main body of the vehicle. The one or more sensors 228 may also or instead include a first camera to detect image data in a forward direction relative to the main body of the vehicle and a second camera to detect image data in a rear direction relative to the main body of the vehicle.

FIGS. 3A and 3B are illustrations of brake pads 300, 310 including electrical impedance material. Referring to FIG. 3A, the brake pad 300 may include a plurality of layers (e.g., 2-6 layers) of electrical impedance material 304A-D. As shown, in one example, there may be four (4) layers of electrical impedance material 304A-D disposed within the brake pad 300, each layer utilized for indicating wearing of 25% of the brake pad 300. However, it would be apparent to one of ordinary skill in the art that the number of the layers of electrical impedance material 304A-D may vary with each layer indicating various levels of wearing of the brake pad 300.

One or more wires 301 (sometimes referred to as a wire mesh) may connect the layers of electrical impedance material 304A-D to an ECU (e.g., a vehicle ECU, the intelligent braking ECU 112, the intelligent braking ECU 212, or the like), wherein one end of the one or more wires 301 may be connected to a voltage source (e.g., of 5V) and another end of the one or more wires 301 may be connected to a ground (GND). In the example illustrated in FIG. 3A, when all layers of electrical impedance material 304A-D are present, a sensor (not shown) connected to the ECU may detect (based on the amount of impedance of each layer of electrical impedance material (e.g., 1,000 ohms)) a prescribed level of current (e.g., 5V/(4×1,000 ohms)=1.25 mA), which may indicate that, e.g., at least 75% of the brake pad 300 is remaining.

Now referring to FIG. 3B, the brake pad 310 with less than 50% of the brake pad material remaining is illustrated. In this example, when a portion of the brake pad 310 (e.g., 50% or more) has worn out, the top two layers of electrical impedance material (e.g., the layers 304A and 304B in FIG. 3A) would have worn out, and the remaining layers of electrical impedance material (e.g., the layers 304C and 304D in FIG. 3A) may yield less impedance based on the remaining layers of electrical impedance material (e.g., 2×1,000 ohms). Then, the detected level of current (e.g., 5V/(2×1,000 ohms)=2.5 mA) would indicate that only a percentage (e.g., more than 25% but less than 50%) of the brake pad 310 remains after the aforementioned portion of the brake pad 310 has worn out. Hence, the ECU (i.e., the vehicle ECU, the intelligent braking ECU 112, the intelligent braking ECU 212, or the like) may measure or receive the detected level of current from the sensor discussed above and determine the amount of the brake pad 310 which has been worn out (and/or how much of the brake pad 310 is remaining).

As shown and referring back to FIG. 3A, the brake pad 300 may have the layers of electrical impedance material 304A-D between brake pad sections 302 to enable the ECU to detect how much of the brake pad 300 has been worn out. In some embodiments, the layers of electrical impedance material 304A-D (which may be made of a different material than the brake pad sections 302) may be isolated from the brake pad material of the brake pad sections 302 to provide a more accurate measurement (e.g., by eliminating any effect of the brake pad material on the impedance encountered through the wires 301). Some examples of the electrical impedance material may include Manganin, Nickel Chromium alloy, Constantan, Gold Chromium, or the like. Moreover, the aforementioned isolation may be achieved, e.g., by utilizing a barrier made of non-conductive material around the electrical impedance material.

FIGS. 4A and 4B are illustrations of brake pads 400 and 410 including, respectively, grid sensor material and a grid sensor. Referring to FIG. 4A, the brake pad 400 may include a plurality of wires 406 (e.g., a wire mesh 405) disposed on a plurality of layers of grid sensor material 404A-C which may be connected to the ECU (e.g., a vehicle ECU, the intelligent braking ECU 112, the intelligent braking ECU 212, or the like) via one or more wires 401. The plurality of wires 406 (wherein a plurality of first wires and a plurality of second wires may intersect at an angle (e.g., orthogonally) to form a plurality of regions 409 bounded by a pair of the first wires and a pair of the second wires) may form a wire mesh 405, and each layer of the grid sensor material 404A-C may form a sheet 408. The wire meshes 405 (e.g., made of the plurality of wires 406) may be utilized to monitor each of a plurality of sections of the brake pad layers 402 corresponding to the plurality of regions 409 of the wire meshes 405. For example, the wire meshes 405 may include a plurality of portions with resistive material (not shown) which may be utilized to determine the presence of the brake pad material (e.g., the brake pad layers 402) based on, e.g., the current measured through the various portions of the wire meshes 405 when a predetermined level of voltage is applied. In some embodiments, the wires 401 and/or the wire meshes 405 may be connected to a voltage source and a ground to enable the determinations of the presence of the brake pad material.

In some embodiments, each brake pad layer 402 may be monitored by its own wire mesh 405. Moreover, in some embodiments, the sheet 408 made of the plurality of regions 409 may itself be made of electrical impedance material with the wires 401 going through the plurality of regions 409 (e.g., some or all of the regions 409)—here, the plurality of regions 409 (i.e., of electrical impedance material) may be utilized to determine the presence of the brake pad material (e.g., the brake pad layers 402) based on, e.g., the current measured through the wires 401 going through the plurality of regions 409. Any portion of the plurality of regions 409 (or the wire meshes 405) corresponding to a worn portion of the brake pad layer 402 may itself be worn out and not detected (i.e., the corresponding impedance may be removed), resulting in changed measurements of current indicating an absence of the portion of the plurality of regions 409 (or the wire meshes 405) and accordingly the worn portion of the brake pad layer 402.

While only a limited amount of the wires 401 and 414 are shown in FIGS. 4A and 4B, it would be apparent to one of ordinary skill in the art that more wires/leads may be utilized to make more granular determinations relating to the presence of the brake pad material (i.e., various portions of the brake pad 400, 410). In various embodiments (with reference to FIG. 4A), the wires 401, the wire meshes 405, and/or the sheet 408 including the plurality of regions 409 may be made of material different from the material of the brake pad layers 402 and/or be isolated from the brake pad layers 402 (e.g., via a barrier made of non-conductive material), such that the measurements and sensing described herein are not impacted by the brake pad material.

The monitoring of the individual sections of the brake pad layers 402 may enable detecting, e.g., a non-uniform wearing of the brake pad 410 (e.g., wherein a first portion corresponding to one or more regions of the regions 409 of the brake pad layer 402 may be more worn than a second portion corresponding to one or more other regions of the regions 409 of the brake pad layer 402). Moreover, the plurality of layers of grid sensor material 404A-C may be utilized for detecting a remaining percentage or amount of the brake pad 410.

In some embodiments, the grid sensor of the wires 406 may include non-conductive material (e.g., glass, etc.) or may be separated from the brake pad material of the brake pad layers 402 (e.g., metal, ceramic, etc.). Such a separation (which may be achieved, e.g., by utilizing a barrier made of non-conductive material around the brake pad material) may allow more accurate monitoring of the brake pad layers 402 by, e.g., eliminating any effect of the brake pad material of the brake pad layers 402 on the monitoring.

Moreover, in some embodiments, if the brake pad 400 is made from, e.g., ceramic (that is, a grid sensor or the brake pad 400 may be made of conductive material), an impedance may be measured with the grid sensor or brake pad material itself, which may be utilized to make the determinations related to which portions of the brake pad 400 may be worn. Further, if the material for the brake pad 400 is conductive (and providing some impedance), the brake pad 400 may then be isolated from all conductive material around the brake system (e.g., including caliper, wheel, axle, etc.) which may be grounded, such that the accuracy of the measurements described herein are not affected.

Turning to FIG. 4B, in some embodiments, the wires 414 may be disposed throughout a portion or an entirety of the brake pad 410 (i.e., throughout all layers of the brake pad material 416). The wires 414 may also be positioned or disposed between layers of the brake pad material 416. Such three-dimensional structure of the wires 414 (e.g., a wire mesh “block” 415) may enable a more granular detection and monitoring of the wearing of the brake pad 410. In some embodiments, the remaining portion of the wire mesh block 415 and sensor data detected based on or relating to, e.g., the remaining portion of the wire mesh block 415 may be utilized to determine whether a maximum contact area (e.g., over one or more threshold area values) between the brake pad (e.g., the brake pads 104 or 204) and the rotor (e.g., the rotor 102 or 202) is being achieved. For example, the ECU (e.g., the vehicle ECU, the intelligent braking ECU 112, the intelligent braking ECU 212, or the like) may detect different rates at which different portions of the brake pad 410 are being worn out to determine whether the maximum contact area is being achieved (e.g., based on whether all portions of a surface of the brake pad 410 are being worn at the same or similar rates).

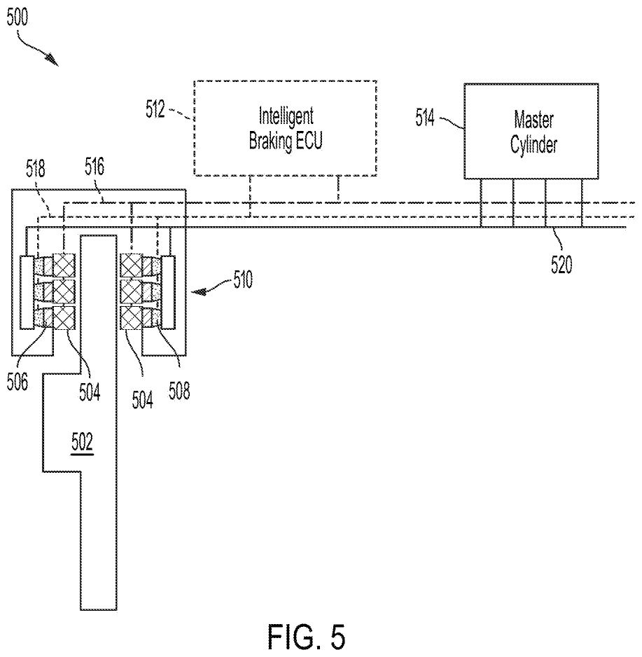

Turning to FIG. 5, a system 500 for intelligently applying a brake on a vehicle is disclosed. The system 500 may include similar components as described herein with respect to FIG. 1, such as, e.g., a rotor 502 (similar to the rotor 102), a plurality of pistons 506 (similar to the plurality of pistons 106), a plurality of regulators 508 (similar to the plurality of regulators 108), a caliper 510 (similar to the caliper 110), an intelligent braking ECU 512 (similar to the intelligent braking ECU 112), a master cylinder 514 (similar to the master cylinder 114), a brake pad sensor line 516 (similar to the brake pad sensor line 116), a regulator control line 518 (similar to the regulator control line 118), and a brake hose 520 (similar to the brake hose 120).

Similar to the components illustrated in FIG. 1, while only a single rotor 502 is illustrated with the other associated components in FIG. 5, it would be apparent to one of ordinary skill in the art that the system 500 may include more than a single set of the components illustrated in FIG. 5, e.g., depending on a number of wheels on the vehicle. Furthermore, the components of the system 500 similar to the corresponding components of the system 100 may have similar structures and perform similar functions as described herein with respect to FIG. 1 and the corresponding components of the system 100.

In various embodiments, the system 500 may also include a plurality of individual brake pads 504 that are separated and independently actuated by the corresponding ones of the plurality of pistons 506. The individual brake pads 504 may be connected, e.g., to the intelligent braking ECU 512 by the brake pad sensor line 516 and may otherwise be similar to the brake pads 104 at least in functionality.

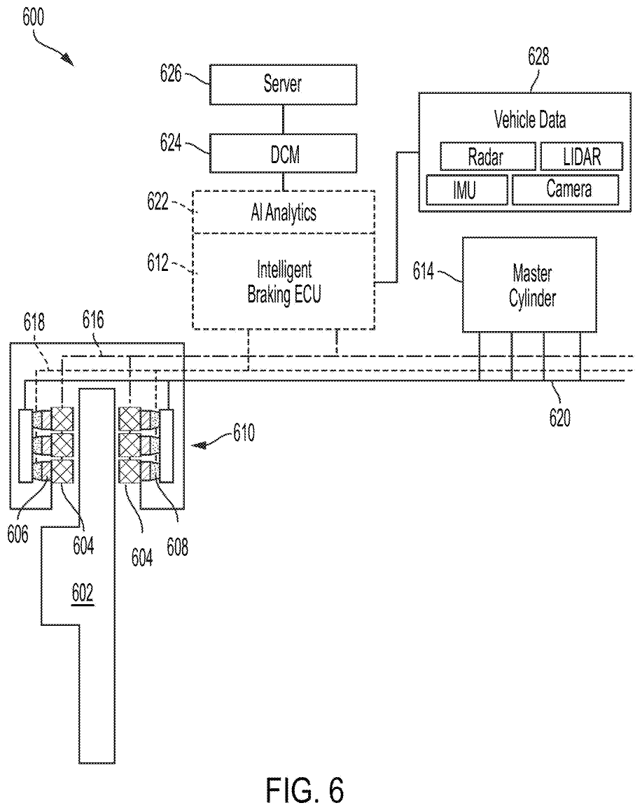

Turning to FIG. 6, a system 600 for intelligently applying a brake on a vehicle is disclosed. The system 600 may include similar components as described herein with respect to FIG. 2, such as, e.g., a rotor 602 (similar to the rotor 202), a plurality of pistons 606 (similar to the plurality of pistons 206), a plurality of regulators 608 (similar to the plurality of regulators 208), a caliper 610 (similar to the caliper 210), an intelligent braking ECU 612 (similar to the intelligent braking ECU 212), a master cylinder 614 (similar to the master cylinder 214), a brake pad sensor line 616 (similar to the brake pad sensor line 216), a regulator control line 618 (similar to the regulator control line 218), a brake hose 620 (similar to the brake hose 220), an artificial intelligence (AI) analytics module or circuitry 622 (similar to the AI analytics module or circuitry 222), a transceiver 624 (similar to the transceiver 224), and one or more sensors 628 (similar to the one or more sensors 228). Similar to the components illustrated in FIG. 2, while only a single rotor 602 is illustrated with the other associated components in FIG. 6, it would be apparent to one of ordinary skill in the art that the system 600 may include more than a single set of the components illustrated in FIG. 6, e.g., depending on a number of wheels on the vehicle. Furthermore, the components of the system 600 similar to the corresponding components of the system 200 may have similar structures and perform similar functions as described herein with respect to FIG. 2 and the corresponding components of the system 200. For example, the transceiver 624 may be referred to as a data communication module (DCM) and be configured to communicate with a remote server 626 (similar to the remote server 226).

In various embodiments, the system 600 may also include a plurality of individual brake pads 604 that are separated and independently actuated by the corresponding ones of the plurality of pistons 606. The individual brake pads 604 may be connected, e.g., to the intelligent braking ECU 612 by the brake pad sensor line 616 and may otherwise be similar to the brake pads 204 at least in functionality.

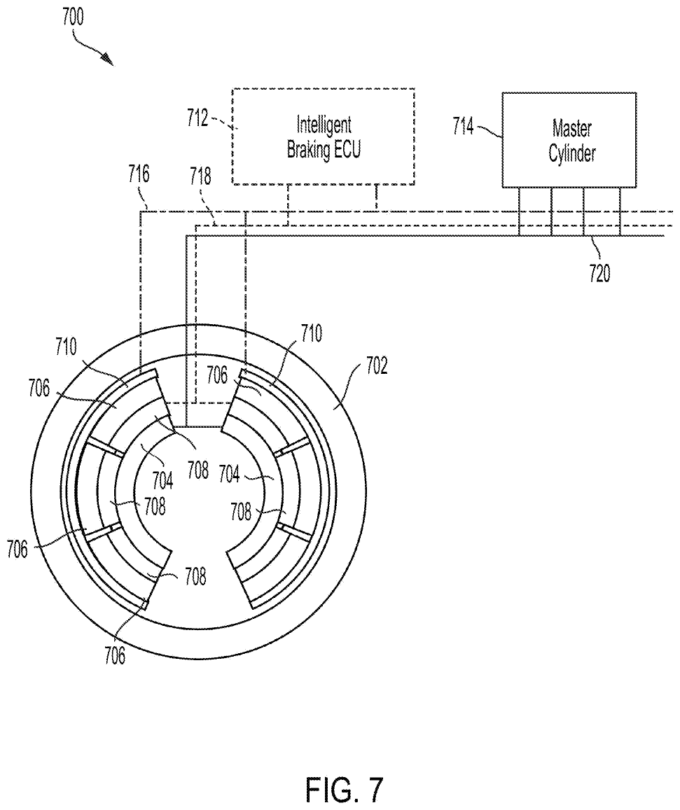

Turning to FIG. 7, a system 700 for intelligently applying a brake on a vehicle is disclosed. The system 700 may include similar components as described herein with respect to FIG. 1, such as, e.g., an intelligent braking ECU 712 (similar to the intelligent braking ECU 112), a master cylinder 714 (similar to the master cylinder 114), a brake shoe sensor line 716 (similar to the brake pad sensor line 116, but connected to one or more sensors configured to detect sensor data regarding a plurality of brake shoes), a regulator control line 718 (similar to the regulator control line 118), and a brake hose 720 (similar to the brake hose 120).

In addition, in various embodiments, the system 700 may also include a brake drum 702, a plurality of connecting portions 704, a plurality of pistons 706, a plurality of regulators 708, and a plurality of brake shoes 710. As may be apparent to one of ordinary skill in the art, the brake drum 702 may be of one or more types well known in the art, and the plurality of brake shoes 710 serve a similar purpose as, e.g., the brake pads 104 described herein with respect to FIG. 1—that is, the brake shoes 710 may be pushed against the brake drum 702 (connected to a wheel of the vehicle—not shown) to slow down or stop movement of the wheel (and thus the movement of the vehicle).

The plurality of pistons 706 and the plurality of regulators 708 may function similarly as the plurality of pistons 106 and the plurality of regulators 108 as described herein with respect to FIG. 1—that is, the plurality of regulators 708 may each control an amount of brake fluid to and/or from each of the plurality of pistons 706. For example, the plurality of regulators 708 may be connected to the corresponding connecting portions 704 and to the master cylinder 714 (via the brake hose 720), wherein the master cylinder 714 may control the movement of the brake fluid to and/or from the plurality of regulators 708. When the brake is to be applied (e.g., based on a driver putting pressure on a brake pedal on the vehicle), the master cylinder 714 may push a predetermined amount of the brake fluid to the plurality of regulators 708 based on sensor data regarding corresponding portions of the brake shoes 710 (e.g., relating to how much of the brake shoes 710 is remaining at the corresponding portions of the brake shoes 710). Then, each of the plurality of regulators 708 may be controlled individually and independently to release a particular amount of the brake fluid for the corresponding one of the plurality of pistons 706. The particular amount of the brake fluid released for each of the plurality of pistons 706 may be determined by the intelligent braking ECU 712 and controlled via a controlling structure such as, e.g., a flap, a valve, etc. (or any structure or method known in the art) in each of the plurality of regulators 708 controlled individually and independently by the intelligent braking ECU 712.

In some embodiments, the plurality of pistons 706 and the plurality of regulators 708 may be actuated and controlled electronically without any brake fluid (i.e., allowing the master cylinder 714 and the brake hose 720 to be optional in such embodiments). That is, the plurality of regulators 708 may receive an electrical signal from the intelligent braking ECU 712 to control the movement of the plurality of pistons 706 individually and independently with respect to the corresponding portions of the brake shoes 710 (e.g., based on the sensor data regarding the corresponding portions of the brake shoes 710 obtained and processed by the intelligent braking ECU 712). In some embodiments, the corresponding portions of the brake shoes 710 may be separated (i.e., physically) and engaged and actuated by the plurality of pistons 706 individually and independently of other portions of the brake shoes 710. A similar configuration with respect to a plurality of individual brake pads 504, 604 is described herein with respect to, respectively, FIGS. 5 and 6. The one or more sensors configured to detect the sensor data regarding the corresponding portions of the brake shoes 710 may be similar to the sensors described herein with respect to FIGS. 3A, 3B, 4A, and 4B.

As illustrated in FIG. 7 and described herein, the intelligent braking ECU 712 may be connected to the brake shoes 710 as well as the plurality of regulators 708. Specifically, in various embodiments, the intelligent braking ECU 712 may be connected via the brake shoe sensor line 716 to the one or more sensors described above with respect to the brake shoes 710 (e.g., with the one or more sensors being part of or being connected to the brake shoes 710). Moreover, the intelligent braking ECU 712 may be connected via the regulator control line 718 to the plurality of regulators 708. The intelligent braking ECU 712 may receive data related to the status of the brake shoes 710 from the one or more sensors connected to or incorporated into the brake shoes 710 (via the brake shoe sensor line 716) and determine the amount of pressure to be applied by each of the plurality of pistons 706 (to be actuated via each of the plurality of regulators 708) against the corresponding portion of the brake shoes 710.

The actuation via each of the plurality of regulators 708 may be (i) based on the data related to the status of the brake shoes 710 (e.g., the percentage or amount of the brake shoes 710 remaining at each of the corresponding portions of the brake shoes 710) and/or (ii) to achieve an even and uniform (i.e., maximized) contact between the brake shoes 710 and the brake drum 702. For example, when a first portion of the brake shoes 710 has a greater percentage or amount of the brake shoe material remaining than a second portion (i.e., the sensor data from the one or more sensors indicates an uneven wear on the brake shoes 710), the first one of the plurality of pistons 706 corresponding to the first portion of the brake shoes 710 may be pushed less than a second one of the plurality of pistons 706 corresponding to the second portion of the brake shoes 710 such that the contact between the first portion of the brake shoes 710 and the brake drum 702 and the contact between the second portion of the brake shoes 710 and the brake drum 702 are even. The plurality of connecting portions 704, the plurality of pistons 706, the plurality of regulators 708, and the plurality of brake shoes 710 may be disposed radially inward from the brake drum 702 as shown in FIG. 7.

While only a single brake drum 702 is illustrated with the other associated components in FIG. 7, it would be apparent to one of ordinary skill in the art that the system 700 may include more than a single set of the components illustrated in FIG. 7, e.g., depending on a number of wheels on the vehicle. Furthermore, the components of the system 700 similar to the corresponding components of the system 100 may have similar structures and perform similar functions as described herein with respect to FIG. 1 and the corresponding components of the system 100.

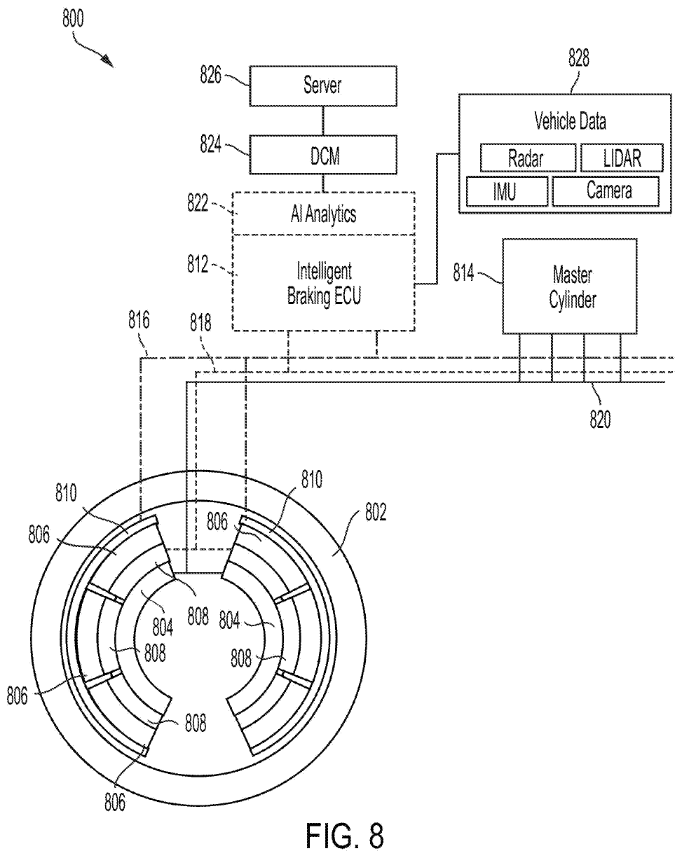

Turning to FIG. 8, a system 800 for intelligently applying a brake on a vehicle is disclosed. The system 800 may include similar components as described herein with respect to FIG. 2, such as, e.g., an intelligent braking ECU 812 (similar to the intelligent braking ECU 212), a master cylinder 814 (similar to the master cylinder 214), a regulator control line 818 (similar to the regulator control line 218), a brake hose 820 (similar to the brake hose 220), an artificial intelligence (AI) analytics module or circuitry 822 (similar to the AI analytics module or circuitry 222), a transceiver 824 (similar to the transceiver 224), and one or more sensors 828 (similar to the one or more sensors 228).

Furthermore, the system 800 may include similar components as described herein with respect to FIG. 7, such as, e.g., a brake drum 802 (similar to the brake drum 702), a plurality of connecting portions 804 (similar to the plurality of connecting portions 704), a plurality of pistons 806 (similar to the plurality of pistons 706), a plurality of regulators 808 (similar to the plurality of regulators 708), a plurality of brake shoes 810 (similar to the plurality of brake shoes 710), and a brake shoe sensor line 816 (similar to the brake shoe sensor line 716). Similar to the components illustrated in FIG. 7, while only a single rotor 802 is illustrated with the other associated components in FIG. 8, it would be apparent to one of ordinary skill in the art that the system 800 may include more than a single set of the components illustrated in FIG. 8, e.g., depending on a number of wheels on the vehicle.

The components of the system 800 similar to the corresponding components of, respectively, the system 200 and the system 700 may have similar structures and perform similar functions as described herein with respect to FIG. 2 and the corresponding components of the system 200 and with respect to FIG. 7 and the corresponding components of the system 700. For example, the transceiver 824 may be referred to as a data communication module (DCM) and be configured to communicate with a remote server 826 (similar to the remote server 226).

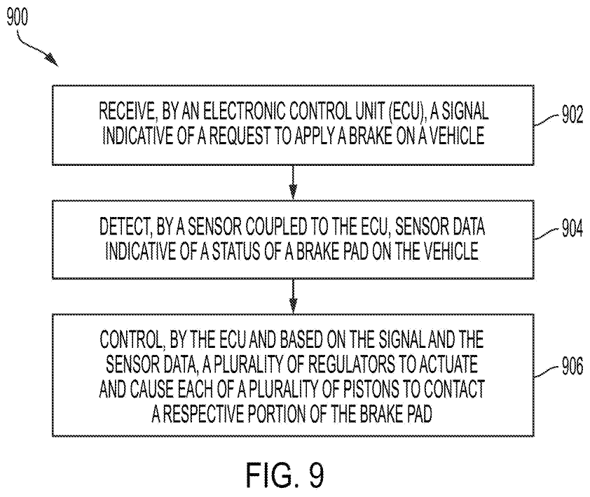

Turning to FIG. 9, a method 900 for intelligently applying a brake on a vehicle is disclosed. The method 900 may be implemented via a plurality of instructions (e.g., a software program) stored on a memory and accessed and processed by a processor (e.g., the intelligent braking ECU 112 and 212 described herein with respect to FIGS. 1 and 2, respectively) to perform the various steps of the method 900.

In step 902, the method 900 includes receiving, by an electronic control unit (ECU), a signal indicative of a request to apply the brake on the vehicle. In some embodiments, the signal may be based on a driver putting pressure on a brake pedal on the vehicle. In some embodiments, the signal may be generated by a vehicle ECU which may be requesting the application of the brake as part of a manual, a semi-autonomous, or an autonomous maneuver of the vehicle. In this regard, the vehicle described herein may be manually driven, semi-autonomously driven, or autonomously driven.

In step 904, the method 900 includes detecting, by a sensor coupled to the ECU, sensor data indicative of a status of a brake pad on the vehicle. The brake pad may be configured to contact a rotor connected to a wheel on the vehicle to slow down or stop movement of the wheel. In some embodiments, the detecting of the sensor data includes detecting a non-uniform wear on the brake pad including a higher level of wear in a first portion of the brake pad than in a second portion of the brake pad, the first portion and the second portion being on a plane across the brake pad parallel to a surface of the rotor positioned adjacent to the brake pad. In some embodiments, the method 900 may include generating and displaying, via a display coupled to the ECU, information related to the non-uniform wear on the brake pad and/or an alert including a warning related to a remaining percentage or amount of the brake pad being at or below a threshold percentage or amount for at least one portion of the brake pad. The alert may also include an indication of a need for a brake pad replacement.

In step 906, the method 900 includes controlling, by the ECU and based on the signal and the sensor data, a plurality of regulators each coupled to a respective piston of a plurality of pistons to actuate and cause the respective piston of the plurality of pistons to contact a respective portion of the brake pad such that the brake pad contacts the rotor to slow down or stop the movement of the wheel.

Where used throughout the specification and the claims, “at least one of A or B” includes “A” only, “B” only, or “A and B.” Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments (e.g., including a singular element where multiple elements are described and/or multiple elements where a singular element is described, etc.) that reasonably fall within the scope of the advancement to the art hereby contributed, and that that scope shall not be restricted, except in light of the appended claims and their equivalents.

What is claimed is:

1. A system for intelligently applying a brake on a vehicle, the system comprising:
a rotor connected to a wheel on the vehicle;
a brake pad positioned adjacent to the rotor and configured to contact the rotor to slow down or stop movement of the rotor such that movement of the wheel is slowed down or stopped;
a plurality of pistons each configured to contact a respective portion of the brake pad to cause the respective portion of the brake pad to contact the rotor;
a plurality of regulators each coupled to a respective piston of the plurality of pistons and configured to control movement of the respective piston of the plurality of pistons;
a sensor configured to detect sensor data related to a status of the brake pad; and
an electronic control unit (ECU) coupled to the plurality of regulators and the sensor and configured to:
receive a signal indicative of a request to apply the brake on the vehicle, and
control the plurality of regulators to cause the brake pad to contact the rotor based on the signal and the sensor data.

2. The system of claim 1, wherein the ECU is further configured to control each regulator of the plurality of regulators independently of other regulators of the plurality of regulators.

3. The system of claim 2, wherein the each regulator is configured to control a flow of brake fluid to control the movement of the respective piston.

4. The system of claim 2, wherein the each regulator is configured to receive an electrical signal for controlling the movement of the respective piston and control the movement of the respective piston based on the received electrical signal.

5. The system of claim 1, further comprising a transceiver coupled to the ECU; and
wherein the ECU is further configured to transmit, via the transceiver, driving behavior data associated with the vehicle to a remote server.

6. The system of claim 5, wherein the driving behavior data is configured to be processed by the remote server for designing an improvement to at least one of the rotor, the brake pad, the plurality of pistons, the plurality of regulators, the sensor, or the ECU.

7. The system of claim 1, further comprising a transceiver coupled to the ECU; and
wherein the ECU is further configured to:
receive driving behavior data associated with one or more vehicles and including first data indicative of a level of driver application of a brake pedal on each of the one or more vehicles and second data indicative of a level of actuation of the brake pad on each of the one or more vehicles from a remote server, and
control the plurality of regulators based on the driving behavior data.

8. The system of claim 7, further comprising an artificial intelligence (AI) analytics circuitry coupled to the ECU; and
wherein the ECU is further configured to:
execute, via the AI analytics circuitry, an AI or machine learning algorithm to process the driving behavior data, and
control the plurality of regulators based on the driving behavior data as processed via the AI or machine learning algorithm.

9. The system of claim 8, wherein the ECU is further configured to:
determine one or more faulty conditions in at least one of the rotor, the brake pad, the plurality of pistons, the plurality of regulators, the sensor, or the ECU based on the driving behavior data as processed via the AI or machine learning algorithm, and
generate and activate an alert related to the one or more faulty conditions.

10. The system of claim 1, further comprising at least one of a radar sensor, a LIDAR sensor, an IMU sensor, or a camera coupled to the ECU and configured to detect one or more road conditions within a predetermined area near the vehicle; and
wherein the ECU is further configured to control the plurality of regulators based on the one or more road conditions.

11. The system of claim 10, wherein the ECU is further configured to activate an anti-lock braking system (ABS) or an autonomous control of the vehicle in response to the detection of the one or more road conditions for an enhanced control of the vehicle when the brake on the vehicle is being applied upon the one or more road conditions being encountered by the vehicle.

12. A vehicle having a system for intelligently applying a brake on the vehicle, the vehicle comprising:
a rotor connected to a wheel on the vehicle;
a brake pad positioned adjacent to the rotor and configured to contact the rotor to slow down or stop movement of the rotor such that movement of the wheel is slowed down or stopped;
a plurality of pistons each configured to contact a respective portion of the brake pad to cause the respective portion of the brake pad to contact the rotor;
a plurality of regulators each coupled to a respective piston of the plurality of pistons and configured to control movement of the respective piston of the plurality of pistons;
a sensor configured to detect sensor data related to a status of the brake pad; and
an electronic control unit (ECU) coupled to the plurality of regulators and the sensor and configured to:
receive a signal indicative of a request to apply the brake on the vehicle, and
control the plurality of regulators to cause the brake pad to contact the rotor based on the signal and the sensor data.

13. The vehicle of claim 12, wherein the brake is a disc brake or a drum brake.

14. The vehicle of claim 12, wherein the sensor data includes a plurality of data each related to the respective portion of the brake pad and indicating a corresponding level of the brake pad remaining at the respective portion.

15. The vehicle of claim 12, wherein the ECU is a dedicated ECU configured to control only the plurality of regulators.

16. The vehicle of claim 12, wherein the ECU is further configured to control one or more other components on the vehicle.

17. A method for intelligently applying a brake on a vehicle, the method comprising:
receiving, by an electronic control unit (ECU), a signal indicative of a request to apply the brake on the vehicle;
detecting, by a sensor coupled to the ECU, sensor data indicative of a status of a brake pad on the vehicle, the brake pad configured to contact a rotor connected to a wheel on the vehicle to slow down or stop movement of the wheel; and
controlling, by the ECU, a plurality of regulators based on the signal and the sensor data, the plurality of regulators each coupled to a respective piston of a plurality of pistons to actuate and cause the respective piston of the plurality of pistons to contact a respective portion of the brake pad such that the brake pad contacts the rotor to slow down or stop the movement of the wheel.

18. The method of claim 17, wherein the detecting of the sensor data includes detecting a non-uniform wear on the brake pad including a higher level of wear in a first portion of the brake pad than in a second portion of the brake pad, the first portion and the second portion being on a plane across the brake pad parallel to a surface of the rotor positioned adjacent to the brake pad.

19. The method of claim 18, further comprising generating and displaying, via a display coupled to the ECU, information related to the non-uniform wear on the brake pad or an alert including a warning related to a remaining percentage or amount of the brake pad being at or below a threshold percentage or amount for at least one portion of the brake pad.

20. The method of claim 19, wherein the generating and the displaying of the alert includes generating and displaying an indicator indicative of a need for a brake pad replacement.
